(19) United States
(12) Patent Application Publication
(10) Pub. No.: US 2026/0203090 A1
(43) Pub. Date: Jul. 16, 2026

(54) SAFETY IN AUTOMOTIVE HOSTED HYPERVISOR SYSTEMS FOR SECURE MONITOR CALLS USING SHARED BUFFERS

(71) Applicant: QUALCOMM Incorporated, San Diego, CA (US)

(72) Inventors: Piyush TEWARI, Lucknow (IN); Nishant RAJ, Bhagalpur (IN); Ananda Kishore PARASA, Hyderabad (IN); Pooja PAWAR, Hyderabad (IN); Amit BLAY, San Diego, CA (US)

(21) Appl. No.: 19/128,918

(22) PCT Filed: Dec. 8, 2023
(86) PCT No.: PCT/US2023/083037

§ 371 Date: May 9, 2025

(30) Foreign Application Priority Data
Jan. 24, 2023 (IL) 300150

(51) Int. Cl. G06F 9/455

(52) U.S. Cl. CPC G06F 9/45558; G06F 2009/45583; G06F 2009/45587

(57) ABSTRACT

Various embodiments include computing devices that are suitable for use automobiles. The computing device may be configured to receive, in a hosted hypervisor, a secure monitor call (SMC) from a guest virtual machine (GVM). In response, the hosted hypervisor may unlink a memory region that is shared by the GVM and a secure execution environment (SEE). The hosted hypervisor may send the SMC to the secure execution environment.

### RELATED APPLICATIONS

This application claims the benefit of priority from Israeli Patent Application No. 300150, filed Jan. 24, 2023; the entire contents of which is herein incorporated by reference.

### BACKGROUND

Over the past several years, the modern automobile has transformed from a self-propelled mechanical vehicle into a powerful and complex electro-mechanical system that includes a large number of electronic components, including multiple electronic displays, microphones, speakers, sensors, control units, processors and systems-on-chips (SOCs) that implement or control many of the vehicle's functions, features, and operations.

Increasingly, the electronic and electrical architecture (EEA) of these vehicles is becoming centralized. For example, it is now common for a single control unit or SOC to perform many the functions of the vehicle. In the future, all functions may be controlled by one centralized vehicle computer. However, various functions may affect other different functions and require different real time abilities, safety levels, and others parameters. Guest virtual machine (GVM) technologies may allow for isolating these different functions withing the same controller or SOC and provide many other benefits. However, GVMs are susceptible to attacks and errors that could cause a system level reset that terminates, interrupts, or otherwise negatively impacts the other functions of the controller or SOC. While such resets may be acceptable in personal electronic devices, they are not acceptable in safety critical systems such as systems providing some level of safety functionality in automobiles.

### SUMMARY

The various aspects include methods performed by one or more processors of computing device, which may include receiving in a hosted hypervisor a secure monitor call (SMC) from a guest virtual machine (GVM), unlinking by the hosted hypervisor a memory region shared by the GVM and a secure execution environment (SEE) in response to the hosted hypervisor receiving the SMC, and sending by the hosted hypervisor the SMC to the secure execution environment.

In some aspects, the method may include receiving in the hosted hypervisor an SMC response from the secure execution environment, relinking by the hosted hypervisor the memory region shared by the GVM and the secure execution environment in response to the hosted hypervisor receiving the SMC response, and sending by the hosted hypervisor the SMC response to the GVM. In some aspects, unlinking the memory region shared by the GVM and the secure execution environment in response to the hosted hypervisor receiving the SMC may include unmapping the memory region shared by the GVM and the secure execution environment.

In some aspects, unlinking the memory region shared by the GVM and the secure execution environment in response to the hosted hypervisor receiving the SMC may include using an intermediate buffer so that the GVM and the secure execution environment access different portions of physical memory to read or write to the memory region shared by the GVM and the secure execution environment. In some aspects, using the intermediate buffer so that the GVM and the secure execution environment access different portions of physical memory to read or write to the memory region shared by the GVM and the secure execution environment may include creating a virtualized memory space for the GVM, and mapping the virtualized memory space to physical memory through the intermediate buffer so that the intermediate buffer acts as a bridge between the GVM and the physical memory.

In some aspects, the method may include receiving the SMC in the secure execution environment, locking by the secure execution environment the memory region shared by the GVM and the secure execution environment, generating by the secure execution environment the SMC response, and sending the SMC response to the hosted hypervisor. In some aspects, locking by the secure execution environment the memory region shared by the GVM and the secure execution environment may include using a Cross-Privilege-Unit (XPU) to lock the memory region shared by the GVM and the secure execution environment. In some aspects, the method may include generating the SMC by the GVM to invoke a secure monitor that controls access to resources in the secure execution environment.

Further aspects may include a computing device having a processor configured with processor-executable instructions to perform various operations corresponding to the methods discussed above.

Further aspects may include a computing device having various means for performing functions corresponding to the method operations discussed above.

Further aspects may include a non-transitory processor-readable storage medium having stored thereon processor-executable instructions configured to cause a processor to perform various operations corresponding to the method operations discussed above.

### BRIEF DESCRIPTION OF THE DRAWINGS

The accompanying drawings, which are incorporated herein and constitute part of this specification, illustrate exemplary embodiments of the claims, and together with the general description given above and the detailed description given below, serve to explain the features of the claims.

FIGS. 1A and 1B are component block diagrams illustrating a vehicle suitable for implementing various embodiments.

FIG. 1C is a component block diagram illustrating components of a vehicle suitable for implementing various embodiments.

FIG. 2 is a component block diagram illustrating components of an example vehicle management system according to various embodiments.

FIG. 3 is a component block diagram that illustrates components in a computing system that could be included in a vehicle and configured in accordance with some embodiments.

FIGS. 4A-4D are component block diagrams that illustrate example computing architectures that are suitable for implementing the various embodiments.

FIGS. 5A and 5B are call flow diagrams that illustrate the components and operations in a system configured to use secure monitor calls (SMC).

FIGS. 6A and 6B are call flow diagrams that illustrate the components and operations in a system configured to unlink memory for secure monitor calls (SMC) in accordance with some embodiments.

FIG. 7 is a process flow diagram that illustrates a method of unlinking shared memory for secure monitor calls (SMC) to prevent system-level resets in accordance with some embodiments.

FIG. 8 is a process flow diagram that illustrates a method of relinking shared memory for secure monitor calls (SMC) in accordance with some embodiments.

FIG. 9 is a process flow diagram that illustrates a method using secure monitor calls (SMC) in accordance with some embodiments.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the claims.

In overview, various embodiments include computing systems that restrict resets to a Guest Virtual Machine (GVM) (as opposed to a system level reset) to minimize the impact to the system and hosted hypervisor for time-of-check to time-of-use (TOCTOU) type vulnerabilities. A hosted hypervisor may be configured to unmap a shared region of memory (a shared buffer) in response to receiving a secure monitor call (SMC) request and until processing is completed by a secure execution environment (e.g., ARM TrustZone). The hosted hypervisor may remap the unmapped shared region before sending a SMC response back to the GVM.

Various embodiments overcome many of the limitations of conventional solutions. For example, by restricting resets to GVM, the various embodiments may prevent a system level reset that impairs the operations and functions of a controller or SOC. Accordingly, various embodiments may be implemented in current and future automotive applications, which may include SOCs that include or implement a vehicle's in-vehicle infotainment (IVI) system, advanced driver assistance system (ADAS), and/or modem telematics system to improve the safety, security, reliability, performance, and/or functionality of a vehicle. Additional enhancements, improvements, and benefits will be evident from the disclosures below.

As used herein, the terms “component,” “system,” “unit,” and the like include a computer-related entity, such as, but not limited to, hardware, firmware, a combination of hardware and software, software, or software in execution, which are configured to perform particular operations or functions. For example, a component may be, but is not limited to, a process running on a processor, a processor, an object, an executable, a thread of execution, a program, and/or a computer. By way of illustration, both an application running on a communication device and the communication device may be referred to as a component. One or more components may reside within a process and/or thread of execution and a component may be localized on one processor or core and/or distributed between two or more processors or cores. In addition, these components may execute from various non-transitory computer readable media having various instructions and/or data structures stored thereon. Components may communicate by way of local and/or remote processes, function or procedure calls, electronic signals, data packets, memory read/writes, and other known computer, processor, and/or process related communication methodologies.

A number of different cellular and mobile communication services and standards are available or contemplated in the future, all of which may implement and benefit from the various embodiments. Such services and standards include, e.g., third generation partnership project (3GPP), long term evolution (LTE) systems, third generation wireless mobile communication technology (3G), fourth generation wireless mobile communication technology (4G), fifth generation wireless mobile communication technology (4G), global system for mobile communications (GSM), universal mobile telecommunications system (UMTS), 3GSM, general packet radio service (GPRS), code division multiple access (CDMA) systems (e.g., cdmaOne, CDMA2000TM), enhanced data rates for GSM evolution (EDGE), advanced mobile phone system (AMPS), digital AMPS (IS-136/TDMA), evolution-data optimized (EV-DO), digital enhanced cordless telecommunications (DECT), Worldwide Interoperability for Microwave Access (WiMAX), wireless local area network (WLAN), Wi-Fi Protected Access I & II (WPA, WPA2), and integrated digital enhanced network (iden). Each of these technologies involves, for example, the transmission and reception of voice, data, signaling, and/or content messages. It should be understood that any references to terminology and/or technical details related to an individual telecommunication standard or technology are for illustrative purposes only, and are not intended to limit the scope of the claims to a particular communication system or technology unless specifically recited in the claim language.

The term “computing device” is used herein to refer to electronic devices having at least a processor, such as computers integrated within a vehicle, but may also include mobile communication devices (e.g., any one or all of cellular telephones, smart-phones, web-pads, tablet computers, Internet enabled cellular telephones, laptop computers, etc.), servers, personal computers, etc. configured to communicate with a vehicle and/or control vehicle operations. In various embodiments, a computing device may be configured with one or more network transceivers or interfaces for establishing communications with other devices. For example, computing devices may include a network interface for establishing a wide area network (WAN) connection (e.g., a Long-Term Evolution cellular network connection, etc.), a short-range wireless connection (e.g., a Bluetooth®, RF, etc.), and/or a local area network (LAN) connection (e.g., a wired or wireless connection to a Wi-Fi® router, etc.).

The term “system on chip” (SOC) is used herein to refer to a single integrated circuit (IC) chip that contains multiple resources and/or processors integrated on a single substrate. A single SOC may contain circuitry for digital, analog, mixed-signal, and radio-frequency functions. A single SOC may also include any number of general purpose and/or specialized processors (digital signal processors, modem processors, video processors, etc.), memory blocks (e.g., ROM, RAM, Flash, etc.), and resources (e.g., timers, voltage regulators, oscillators, etc.). SOCs may also include software for controlling the integrated resources and processors, as well as for controlling peripheral devices.

Generally, a virtual machine (VM) is a software solution that provides an interface between application programs and the physical hardware, potentially allowing application programs tied to a specific instruction set architecture (ISA) to execute on hardware implementing a different ISA. Virtual machine solutions may include a “hypervisor” or virtual machine monitor (VMM) that runs on actual hardware (native) or on top of an operating system (hosted) to emulate the hardware ISA and/or to otherwise provide the application programs with virtualized hardware resources. Each virtual machine may have its own separate operating system image, binaries, libraries, and software applications.

A native hypervisor is a software component that runs directly on a host device's hardware to control the hardware, and to monitor guest operating systems (virtual instances of operating systems). The guest operating system runs on a separate level above the native hypervisor. Examples of native hypervisors include Oracle VM, Microsoft Hyper-V, VMware ESXi and Xen.

A hosted hypervisor is a software component that runs within a traditional operating system. As such, a hosted hypervisor adds a software layer on top of the host operating system, and the guest operating system operates at the third software level above the hardware. Examples of hosted hypervisors includes Oracle VM VirtualBox, Microsoft Virtual PC, KVM, QEMU and Parallels.

A guest virtual machine is a software-based emulation of a physical computer that runs on top of a host operating system. It allows multiple operating systems to run on a single physical machine, providing a way to partition hardware resources and run multiple environments simultaneously. The guest virtual machine operates as an independent entity, with its own operating system, applications, and data, but it relies on the host machine for physical resources such as memory, storage, and processing power. This separation of the guest virtual machine from the host machine allows for greater flexibility and convenience, as it allows users to run different operating systems and applications on a single machine without the need for multiple physical machines.

Generally, a secure monitor call (SMC) is a mechanism to change the processor execution mode from secure to non-secure and vice-versa. When a processor executes the SMC, the processor or core enters a Secure Monitor mode to execute the Secure Monitor code. This call (SMC) may be routed via a Hosted Hypervisor for mode switch in virtualization systems. SMCs may be used for tasks such as requesting access to hardware resources, obtaining information about the entire system, or triggering the host to perform certain actions on behalf of the guest. To prevent unauthorized or malicious access, SMCs are typically implemented with strict security measures, such as authentication and access controls.

The ARM TrustZone is a hardware-based security feature that provides a secure execution environment for sensitive operations on ARM-based computing devices. The ARM TrustZone works by creating two separate execution environments within a single processor: the Normal World and the Secure World. The Normal World is where most of the device's functions operate, including running applications and handling user input. The Secure World is a separate, isolated environment that is used to perform sensitive operations such as handling secure communications and handling sensitive data. TrustZone uses hardware-based isolation to ensure that the Secure World is protected from interference or tampering by the Normal World. This allows for secure operations to be performed on the device without the risk of compromise. TrustZone is commonly used in mobile devices and other devices that handle sensitive information, such as payment systems and government systems.

A Cross-Privilege-Unit (XPU) is a hardware feature in some processors that may be used to enforce security boundaries, such as between the secure and normal worlds of the secure execution environment. The XPU may accomplish this by preventing the normal world from accessing certain resources (e.g., buffers, registers, etc.) that should only be accessible to the secure world. These resources include buffers used to temporarily store data during processing. Locking the buffers via the XPU during processing helps to ensure that sensitive data in the secure world is protected from tampering or exploitation by processes in the normal world. Using conventional solutions, an attempt to access a locked buffer processes in the normal world may generate an XPU fault that causes a system level reset. XPU is sometimes aliased and used as an External Protection Unit, which may be part of a computer security architecture (e.g., ARM based SOCs, etc.) and can be used in conjunction with other security measures (e.g., virtualization, TrustZone, etc.).

Time-of-check to time-of-use (TOCTOU) is a type of vulnerability that can occur in computer systems when a resource is checked for certain conditions before it is used, but the conditions may have changed by the time the resource is actually used. This may happen because there is a time gap between the point at which a system checks the validity of an action (such as checking if a user has sufficient privileges to perform an action) and the point at which the action is actually carried out. During this time gap, an attacker may be able to intervene and manipulate the system in a way that allows them to bypass the initial check and perform the action anyway. This can lead to security vulnerabilities and is something that should be addressed in order to maintain the integrity and security of a system. TOCTOU vulnerabilities may lead various security risks such as privilege escalation, data tampering, and denial of service attacks.

A secondary stage Memory Management Unit (S2MMU) may be a component in a computing device's memory management system that is responsible for managing the translation of virtual addresses to physical addresses in the system's main memory. A memory management unit (MMU) is a hardware component that is responsible for managing the mapping of virtual addresses to physical addresses in a computer's main memory. In a system with an S2MMU, the primary MMU is responsible for managing the mapping of virtual addresses to intermediate physical addresses, while the S2MMU is responsible for managing the mapping of intermediate physical addresses to the final physical addresses in main memory. The use of an S2MMU can allow for more flexible and efficient memory management in a system, as it allows for the use of multiple levels of intermediate physical addresses and the ability to perform more advanced memory management operations. It is often used in systems with large amounts of main memory or in systems that require advanced memory management features such as memory protection or virtualization.

Various embodiments may restrict resets to the GVM instead of system reset so that the entire system (including the hosted hypervisor) is not impacted for TOCTOU. In various embodiments, when a hosted hypervisor receives an SMC, the hosted hypervisor may un-map a shared region memory between the GVM and secure execution environment from the GVM's secondary stage Memory Management Unit (S2MMU) when the GVM's SMC reaches the hosted hypervisor and before the hosted hypervisor hands the SMC call over to the secure execution environment. The hosted hypervisor may ensure that the memory remains unmapped until the processing by the secure execution environment is completed. The hosted hypervisor may remap (map back) the shared buffer to the GVM's S2MMU before sending the SMC call result back to the GVM. As a result, while a TOCTOU type vulnerability may cause a S2 MMU fault that leads to a crash of the GVM, the S2 MMU fault will not cause an XPU fault that forces a system level reset. In addition, un-mapping the memory allows the hosted hypervisor to send the SMC to the secure execution environment without significant delay, thereby improving the system's security without having a significant negative impact on the latency of the SMCs. This in turn improves the performance and functioning of the controller, SOC, and/or vehicle.

In some embodiments, rather than un-mapping the memory, the hosted hypervisor may use intermediate buffers so that the GVM and secure execution environment will not attempt to access the same memory region at the same time.

Various embodiments improve the reliability of computing devices having a hypervisor and a GVM by preventing a general reset of the entire computing device, including the hypervisor, in response to a TOCTOU vulnerability event. In computing devices implemented in vehicles, various embodiments can improve vehicle safety by preventing a reset of safety related functionality in response to a TOCTOU vulnerability event of a GVM hosted in the vehicle's computing device.

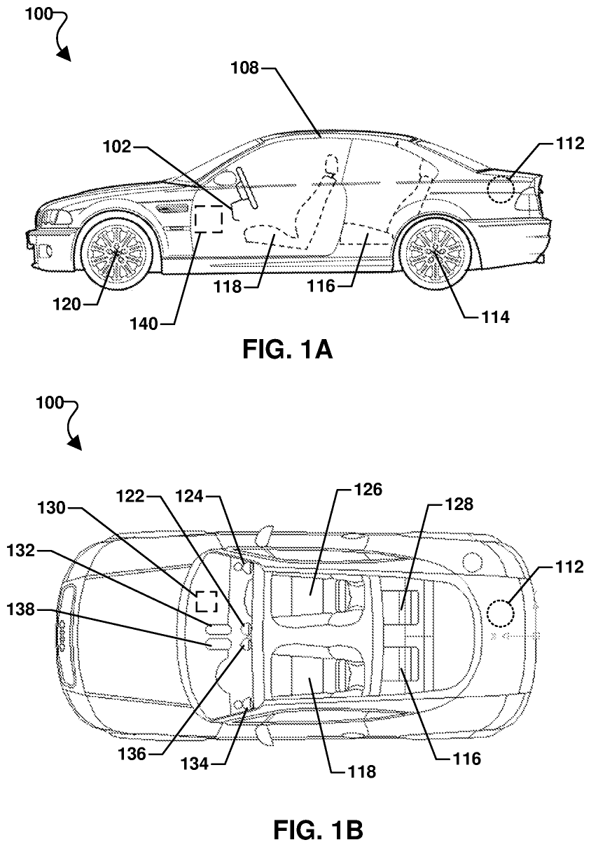

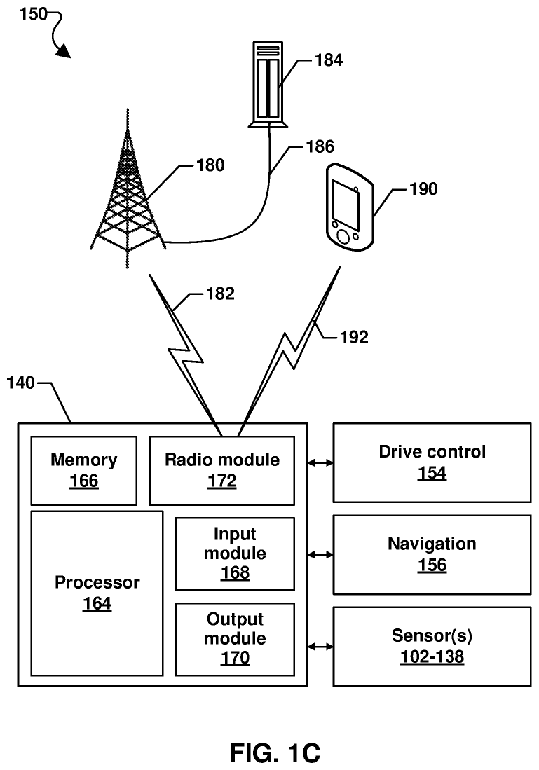

Various embodiments may be implemented within a variety of host vehicles, an example vehicle 100 of which is illustrated in FIGS. 1A and 1B. With reference to FIGS. 1A and 1B, a host vehicle 100 may include a plurality of sensors 102-138 disposed in or on the host vehicle that are used for various purposes involved in navigation as well as sensor data regarding objects and people in or on the host vehicle 100. The sensors 102-138 may include one or more of a wide variety of sensors capable of detecting a variety of information useful for navigation and collision avoidance. Each of the sensors 102-138 may be in wired or wireless communication with a control unit 140, as well as with each other. In particular, the sensors may include one or more cameras 122, 136 or other optical sensors or photo optic sensors. The sensors may further include other types of object detection and ranging sensors 132, 138, IR sensors, and ultrasonic sensors. The sensors may further include tire pressure sensors 114, 120, humidity sensors, temperature sensors, satellite geopositioning sensors 108, accelerometers, vibration sensors, gyroscopes, gravimeters, impact sensors 130, force meters, stress meters, strain sensors, environmental sensors, microphones 124, 134, occupancy sensors 112, 116, 118, 126, 128, proximity sensors, and other sensors.

The host vehicle control unit 140 may be configured with processor-executable instructions to perform various embodiments using information received from various sensors, such as the cameras 122, 136. In some embodiments, the control unit 140 may supplement the processing of camera images using distance and relative position (e.g., relative bearing angle) that may be obtained from detection and ranging sensors 132, 138. The control unit 140 may further be configured to control steering, breaking and speed of the host vehicle 100 when operating in driver assist mode using information regarding other vehicles determined using various embodiments. In some embodiments, the control unit 140 may be configured to implement all or portions of the vehicle driving assist system.

FIG. 1C is a component block diagram illustrating a system 150 of components and support systems suitable for implementing various embodiments. With reference to FIGS. 1A, 1B, and 1C, a host vehicle 100 may include a control unit 140, which may include various circuits and devices used to control the operation of the host vehicle 100. The control unit 140 may be coupled to and configured to control drive control components 154, navigation components 156, and one or more sensors 102-138 of the host vehicle 100.

The control unit 140 may include a processor 164 configured with processor-executable instructions to control maneuvering, navigation, and other operations of the host vehicle 100, including operations of various embodiments. The processor 164 may be coupled to a memory 166. The control unit 140 may include an input module 168, an output module 170, and a radio module 172. In some embodiments, the processor 164 may be configured to implement the functions of the vehicle driving assist system.

The radio module 172 may be configured for wireless communication. The radio module 172 may exchange signals 182 (e.g., command signals for controlling maneuvering, signals from navigation facilities, etc.) with a network transceiver 180, and may provide the signals 182 to the processor 164 and/or the navigation unit 156. In some embodiments, the radio module 172 may enable the host vehicle 100 to communicate with a wireless communication device 190 through a wireless communication link 192. The wireless communication link 192 may be a bidirectional or unidirectional communication link, and may use one or more communication protocols.

The input module 168 may receive sensor data from one or more vehicle sensors 102-138 as well as electronic signals from other components, including the drive control components 154 and the navigation components 156. The output module 170 may be used to communicate with or activate various components of the host vehicle 100, including the drive control components 154, the navigation components 156, and the sensor(s) 102-138.

The control unit 140 may be coupled to the drive control components 154 to control physical elements of the host vehicle 100 related to maneuvering and navigation of the host vehicle, such as the engine, motors, throttles, steering elements, flight control elements, braking or deceleration elements, and the like. The drive control components 154 may also include components that control other devices of the host vehicle, including environmental controls (e.g., air conditioning and heating), external and/or interior lighting, interior and/or exterior informational displays (which may include a display screen or other devices to display information), and other similar devices.

The control unit 140 may be coupled to the navigation components 156, and may receive data from the navigation components 156 and be configured to use such data to determine the present position and orientation of the host vehicle 100, as well as an appropriate course toward a destination. In various embodiments, the navigation components 156 may include or be coupled to a global navigation satellite system (GNSS) receiver system (e.g., one or more Global Positioning System (GPS) receivers) enabling the host vehicle 100 to determine its current position using GNSS signals. Alternatively or in addition, the navigation components 156 may include radio navigation receivers for receiving navigation beacons or other signals from radio nodes, such as Wi-Fi access points, cellular network sites, radio station, remote computing devices, other vehicles, etc. Through control of the drive control elements 154, the processor 164 may control the host vehicle 100 to navigate and maneuver. The processor 164 and/or the navigation components 156 may be configured to communicate with a server 184 on a network 186 (e.g., the Internet) using a wireless connection 182 with a cellular data network 180 to receive commands to control maneuvering, receive data useful in navigation, provide real-time position reports, and assess other data.

The control unit 140 may be coupled to one or more sensors 102-138 as described, and may be configured to provide a variety of data to the processor 164.

While the control unit 140 is described as including separate components, in some embodiments some or all of the components (e.g., the processor 164, the memory 166, the input module 168, the output module 170, and the radio module 172) may be integrated in a single device or module, such as a system-on-chip (SOC) processing device. Such an SOC processing device may be configured for use in vehicles and be configured, such as with processor-executable instructions executing in the processor 164, to perform operations of various embodiments when installed into a host vehicle.

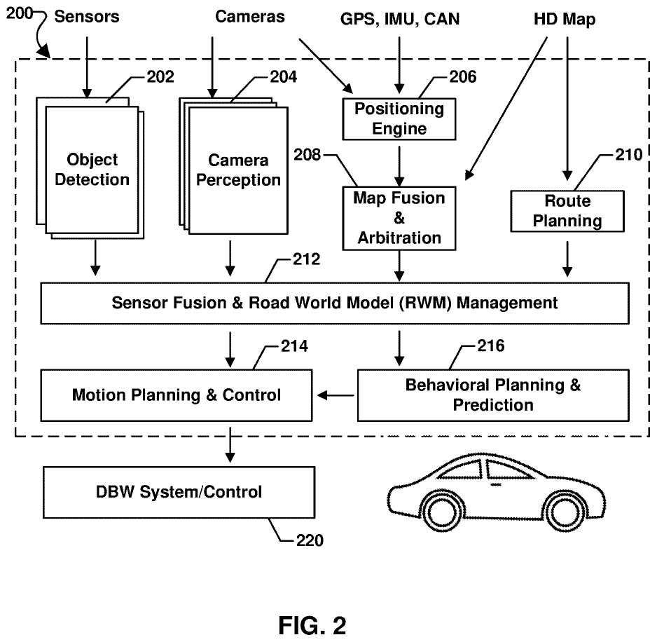

FIG. 2 illustrates an example of subsystems, computational elements, computing devices or units within vehicle management system 200, which may be utilized within a host vehicle 100. In some embodiments, the various computational elements, computing devices or units within vehicle management system 200 may be implemented within a system of interconnected computing devices (i.e., subsystems), that communicate data and commands to each other (e.g., indicated by the arrows in FIG. 2). In other embodiments, the various computational elements, computing devices or units within vehicle management system 200 may be implemented within a single computing device, such as separate threads, processes, algorithms or computational elements. Therefore, each subsystem/computational element illustrated in FIG. 2 is also generally referred to herein as “layer” within a computational “stack” that constitutes the vehicle management system 200. However, the use of the terms layer and stack in describing various embodiments are not intended to imply or require that the corresponding functionality is implemented within a single vehicle control system computing device, although that is a potential implementation embodiment. Rather the use of the term “layer” is intended to encompass subsystems with independent processors, computational elements (e.g., threads, algorithms, subroutines, etc.) running in one or more computing devices, and combinations of subsystems and computational elements.

With reference to FIGS. 1A-2, the vehicle management system stack 200 may include an object detection layer 202, a camera perception layer 204, a positioning engine layer 206, a map fusion and arbitration layer 208, a route planning layer 210, sensor fusion and road world model (RWM) management layer 212, motion planning and control layer 214, and behavioral planning and prediction layer 216. The layers 202-216 are merely examples of some layers in one example configuration of the vehicle management system stack 200 and in other configurations other layers may be included, such as additional layers for other perception sensors, additional layers for planning and/or control, additional layers for modeling, additional layers for implementing the vehicle driving assistance system, etc., and/or certain of the layers 202-216 may be excluded from the vehicle management system stack 200. Each of the layers 202-216 may exchange data, computational results and commands as illustrated by the arrows in FIG. 2. Further, the vehicle management system stack 200 may receive and process data from sensors (e.g., external sensors, cameras, inertial measurement units (IMU) etc.), navigation systems (e.g., GPS receivers, IMUs, etc.), vehicle networks (e.g., Controller Area Network (CAN) bus), and databases in memory (e.g., digital map data). The vehicle management system stack 200 may output vehicle control commands or signals to the drive by wire (DBW) system/control unit 220, which is a system, subsystem or computing device that interfaces directly with vehicle steering, throttle and brake controls.

The object detection layer 202 may receive data from one or more detection and ranging sensors 132, 138, and process the data to recognize and determine locations of other vehicles and objects within a vicinity of the host vehicle 100. The object detection layer 202 may include use of neural network processing and artificial intelligence methods to recognize objects and vehicles, and pass such information on to the sensor fusion and RWM management layer 212.

The camera perception layer 204 may receive data from one or more cameras, such as cameras 122, 136, and process the data to recognize and determine locations of other vehicles and objects within a vicinity of the host vehicle 100. The camera perception layer 204 may include use of neural network processing and artificial intelligence methods to recognize objects and vehicles, and pass such information on to the sensor fusion and RWM management layer 212.

The positioning engine layer 206 may receive data from various sensors and process the data to determine a position of the host vehicle 100. The various sensors may include, but is not limited to, a GPS receiver, an IMU, and/or other sensors connected via a CAN bus. The positioning engine layer 206 may also utilize inputs from one or more cameras, such as cameras 122, 136, detection and ranging sensors 132, 138 and/or any other available sensor.

The map fusion and arbitration layer 208 may access data within a high definition (HD) map database and receive output received from the positioning engine layer 206 and process the data to further determine the position of the host vehicle 100 within the map, such as location within a lane of traffic, position within a street map, etc. The HD map database may be stored in a memory, such as memory 166. For example, the map fusion and arbitration layer 208 may convert latitude and longitude information from GPS into locations within a surface map of roads contained in the HD map database. GPS position fixes include errors, so the map fusion and arbitration layer 208 may function to determine a best guess location of the host vehicle within a roadway based upon an arbitration between the GPS coordinates and the HD map data. For example, while GPS coordinates may place the host vehicle near the middle of a two-lane road in the HD map, the map fusion and arbitration layer 208 may determine from the direction of travel that the host vehicle is most likely aligned with the travel lane consistent with the direction of travel. The map fusion and arbitration layer 208 may pass map-based location information to the sensor fusion and RWM management layer 212.

The route planning layer 210 may utilize the HD map, as well as inputs from an operator or dispatcher to plan a route to be followed by the host vehicle 100 to a particular destination. The route planning layer 210 may pass map-based location information to the sensor fusion and RWM management layer 212. However, the use of a prior map by other layers, such as the sensor fusion and RWM management layer 212, etc., is not required. For example, other stacks may operate and/or control the vehicle based on perceptual data alone without a provided map, constructing lanes, boundaries, and the notion of a local map as perceptual data is received.

The sensor fusion and RWM management 212 may receive data and outputs produced by the object detection layer 202, camera perception layer 204, map fusion and arbitration layer 208, and route planning layer 210, and use some or all of such inputs to estimate or refine the location and state of the host vehicle 100 in relation to the road, other vehicles on the road, and other objects within a vicinity of the host vehicle 100. For example, the sensor fusion and RWM management 212 may combine imagery data from the camera perception layer 204 with arbitrated map location information from the map fusion and arbitration layer 208 to refine the determined position of the host vehicle within a lane of traffic. As another example, the sensor fusion and RWM management 212 may combine object recognition and imagery data from the camera perception layer 204 with object detection and ranging data from the object detection layer 202 to determine and refine the relative position of other vehicles and objects in the vicinity of the host vehicle. As another example, the sensor fusion and RWM management 212 may receive information from vehicle-to-vehicle (V2V) communications (such as via the CAN bus) regarding other vehicle positions and directions of travel, and combine that information with information from the object detection layer 202 and the camera perception layer 204 to refine the locations and motions of other vehicles. The sensor fusion and RWM management 212 may output refined location and state information of the host vehicle 100, as well as refined location and state information of other vehicles and objects in the vicinity of the host vehicle, to the motion planning and control layer 214 and/or the behavior planning and prediction layer 216.

The behavioral planning and prediction layer 216 may use the refined location and state information of the host vehicle 100 and location and state information of other vehicles and objects output from the sensor fusion and RWM management layer 212 to predict future behaviors of other vehicles and/or objects. For example, the behavioral planning and prediction layer 216 may use such information to predict future relative positions of other vehicles in the vicinity of the host vehicle based on own vehicle position and velocity and other vehicle positions and velocity. Such predictions may take into account information from the HD map and route planning to anticipate changes in relative vehicle positions as host and other vehicles follow the roadway. The behavioral planning and prediction layer 216 may output other vehicle and object behavior and location predictions to the motion planning and control layer 214.

Additionally, the behavior planning and prediction layer 216 may plan and generate control signals for controlling the motion of the host vehicle 100. For example, based on route planning information, refined location in the roadway information, and relative locations and motions of other vehicles, the behavior planning and prediction layer 216 may determine that the host vehicle 100 needs to change lanes and accelerate, such as to maintain or achieve minimum spacing from other vehicles, and/or prepare for a turn or exit. As a result, the behavior planning and prediction layer 216 may calculate or otherwise determine a steering angle for the wheels and a change to the throttle to be commanded to the motion planning and control layer 214 and DBW system control layer 220 along with such various parameters necessary to effectuate such lane change and accelerate. One such parameter may be a computed steering wheel command angle.

The motion planning and control layer 214 may receive data and information outputs from the sensor fusion and RWM management layer 212 and other vehicle and object behavior as well as location predictions from the behavior planning and prediction layer 216, and use this information to plan and generate control signals for controlling the motion of the host vehicle 100 and to verify that such control signals meet safety requirements for the host vehicle 100. For example, based on route planning information, refined location in the roadway information, and relative locations and motions of other vehicles, the motion planning and control layer 214 may verify and pass various control commands or instructions to the DBW system/control unit 220.

The DBW system/control unit 220 may receive the commands or instructions from the motion planning and control layer 214 and translate such information into mechanical control signals for controlling wheel angle, brake and throttle of the host vehicle 100. For example, DBW system/control 220 may respond to the computed steering wheel command angle by sending corresponding control signals to the steering wheel controller.

In various embodiments, the vehicle management system stack 200 may include functionality that performs safety checks or oversight of various commands, planning or other decisions of various layers that could impact vehicle and occupant safety. Such safety check or oversight functionality may be implemented within a dedicated layer (not shown) or distributed among various layers and included as part of the functionality. In some embodiments, a variety of safety parameters may be stored in memory and the safety checks or oversight functionality may compare a determined value (e.g., relative spacing to a nearby vehicle, distance from the roadway centerline, etc.) to corresponding safety parameter(s), and issue a warning or command if the safety parameter is or will be violated. For example, a safety or oversight function in the behavior planning and prediction layer 216 (or in a separate layer not shown) may determine the current or future separate distance between another vehicle (as refined by the sensor fusion and RWM management layer 212) and the host vehicle (e.g., based on the world model refined by the sensor fusion and RWM management layer 212), compare that separation distance to a safe separation distance parameter stored in memory, and issue instructions to the motion planning and control layer 214 to speed up, slow down or turn if the current or predicted separation distance violates the safe separation distance parameter. As another example, safety or oversight functionality in the motion planning and control layer 214 (or a separate layer not shown) may compare a determined or commanded steering wheel command angle to a safe wheel angle limit or parameter, and issue an override command and/or alarm in response to the commanded angle exceeding the safe wheel angle limit.

Some safety parameters stored in memory may be static (i.e., unchanging over time), such as maximum vehicle speed. Other safety parameters stored in memory may be dynamic in that the parameters are determined or updated continuously or periodically based on vehicle state information and/or environmental conditions. Non-limiting examples of safety parameters include maximum safe speed, maximum brake pressure, maximum acceleration, and the safe wheel angle limit, all of which may be a function of roadway and weather conditions.

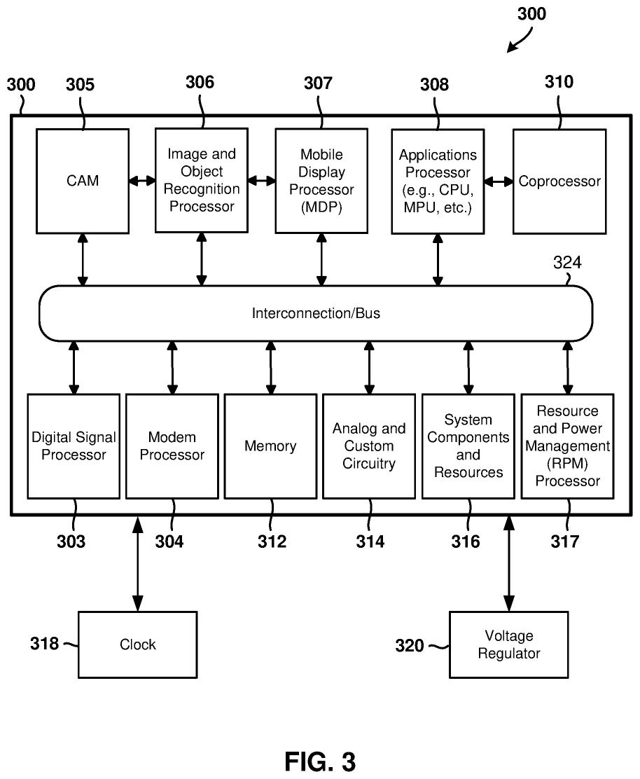

FIG. 3 illustrates an example system-on-chip (SOC) architecture of a processing device SOC 300 suitable for implementing various embodiments in vehicles. With reference to FIGS. 1A-3, the processing device SOC 300 may include a number of heterogeneous processors, such as a digital signal processor (DSP) 303, a modem processor 304, an image and object recognition processor 306, a mobile display processor (MDP) 307, an applications processor 308, and a resource and power management (RPM) processor 317. The processing device SOC 300 may also include one or more coprocessors 310 (e.g., vector co-processor) connected to one or more of the heterogeneous processors 303, 304, 306, 307, 308, 317. Each of the processors may include one or more cores, and an independent/internal clock. Each processor/core may perform operations independent of the other processors/cores. For example, the processing device SOC 300 may include a processor that executes a first type of operating system (e.g., FreeBSD, LINUX, OS X, etc.) and a processor that executes a second type of operating system (e.g., Microsoft Windows). In some embodiments, the applications processor 308 may be the SOC's 300 main processor, central processing unit (CPU), microprocessor unit (MPU), arithmetic logic unit (ALU), etc. The graphics processor 306 may be graphics processing unit (GPU).

In some embodiments, one or more of the heterogeneous processors 303, 304, 306, 307, 308, 317 may be configured to implement all or portions of the vehicle driver assist system.

The processing device SOC 300 may include analog circuitry and custom circuitry 314 for managing sensor data, analog-to-digital conversions, wireless data transmissions, and for performing other specialized operations, such as processing encoded audio and video signals for rendering in a web browser. The processing device SOC 300 may further include system components and resources 316, such as voltage regulators, oscillators, phase-locked loops, peripheral bridges, data controllers, memory controllers, system controllers, access ports, timers, and other similar components used to support the processors and software clients (e.g., a web browser) running on a computing device.

The processing device SOC 300 also include specialized circuitry (CAM) 305 that includes, provides, controls and/or manages the operations of one or more cameras 122, 136 (e.g., a primary camera, webcam, 3D camera, etc.), the video display data from camera firmware, image processing, video preprocessing, video front-end (VFE), in-line JPEG, high definition video codec, etc. The CAM 305 may be an independent processing unit and/or include an independent or internal clock.

In some embodiments, the image and object recognition processor 306 may be configured with processor-executable instructions and/or specialized hardware configured to perform image processing and object recognition analyses involved in various embodiments. For example, the image and object recognition processor 306 may be configured to perform the operations of processing images received from cameras (e.g., 122, 136) via the CAM 305 to recognize and/or identify other vehicles, and otherwise perform functions of the camera perception layer 204 as described. In some embodiments, the processor 306 may be configured to process external sensor data and perform functions of the object detection layer 202 as described.

The system components and resources 316, analog and custom circuitry 314, and/or CAM 305 may include circuitry to interface with peripheral devices, such as cameras 122, 136, detection and ranging sensors 132, 138, electronic displays, wireless communication devices, external memory chips, etc. The processors 303, 304, 306, 307, 308 may be interconnected to one or more memory elements 312, system components and resources 316, analog and custom circuitry 314, CAM 305, and RPM processor 317 via an interconnection/bus module 324, which may include an array of reconfigurable logic gates and/or implement a bus architecture (e.g., CoreConnect, AMBA, etc.). Communications may be provided by advanced interconnects, such as high-performance networks-on chip (NoCs).

The processing device SOC 300 may further include an input/output module (not illustrated) for communicating with resources external to the SOC, such as a clock 318 and a voltage regulator 320. Resources external to the SOC (e.g., clock 318, voltage regulator 320) may be shared by two or more of the internal SOC processors/cores (e.g., a DSP 303, a modem processor 304, a graphics processor 306, an applications processor 308, etc.).

In some embodiments, the processing device SOC 300 may be included in a control unit (e.g., 140) for use in a vehicle (e.g., 100). The control unit may include communication links for communication with a telephone network (e.g., 180), the Internet, and/or a network server (e.g., 184) as described.

The processing device SOC 300 may also include additional hardware and/or software components that are suitable for collecting sensor data from sensors, including motion sensors (e.g., accelerometers and gyroscopes of an IMU), user interface elements (e.g., input buttons, touch screen display, etc.), microphone arrays, sensors for monitoring physical conditions (e.g., location, direction, motion, orientation, vibration, pressure, etc.), cameras, compasses, GPS receivers, communications circuitry (e.g., Bluetooth®, WLAN, WiFi, etc.), and other well-known components of modern electronic devices.

In some embodiments, the processing device SOC 300 may implement a layered architecture and/or may be configured to utilize virtualization techniques. Virtualization technologies enable the abstraction (or virtualization) of computing resources, which may be achieved by placing a control program (e.g., a Virtual Machine Monitor “VMM” or hypervisor) between the operating system and the hardware. Virtualization techniques are commonly implemented in a virtual machine (VM), which may be a software application that executes application programs like a physical hardware machine. The virtual machine provides an interface between application programs and the execution hardware, allowing application programs tied to a specific instruction set architecture to execute on hardware implementing a different instruction set architecture.

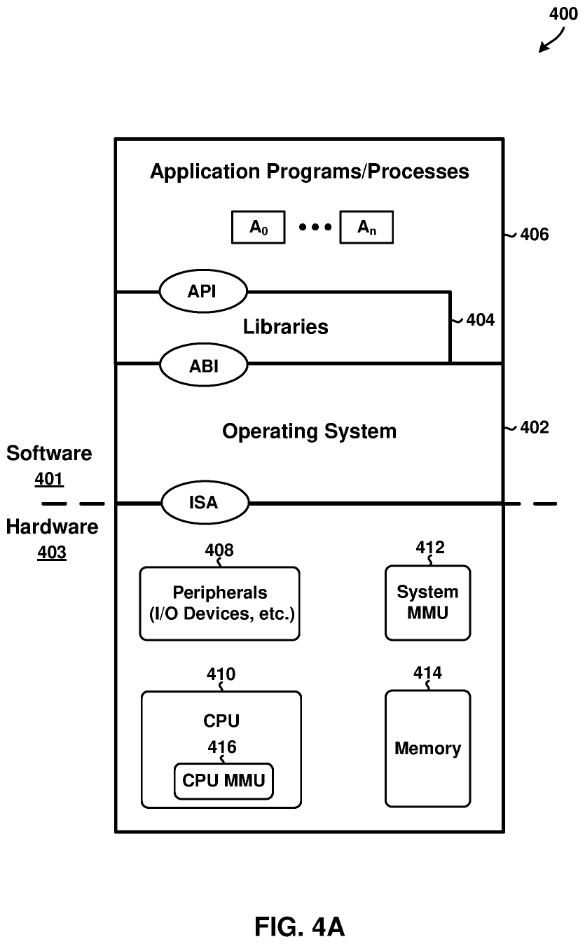

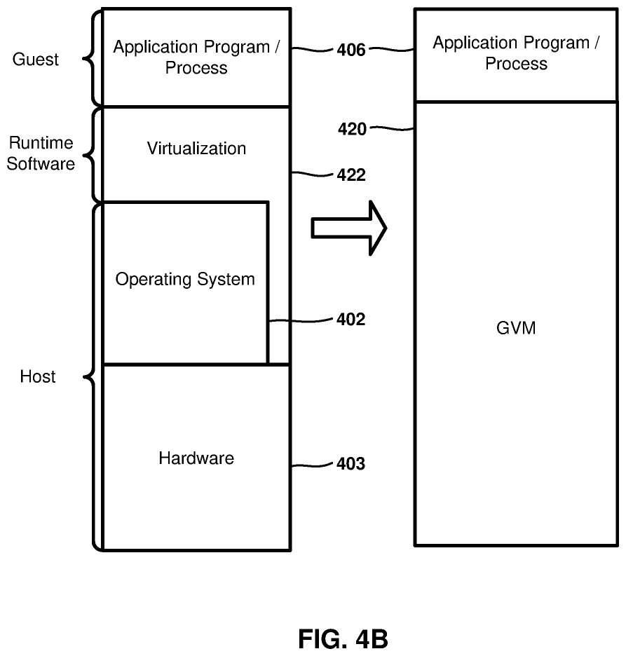

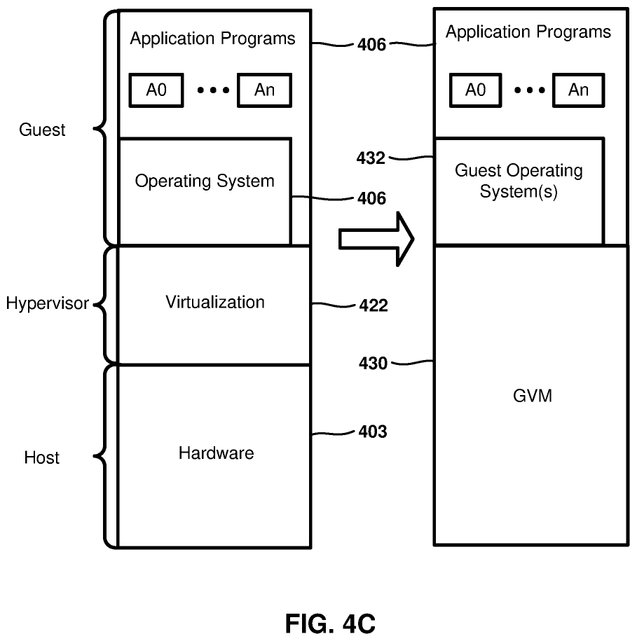

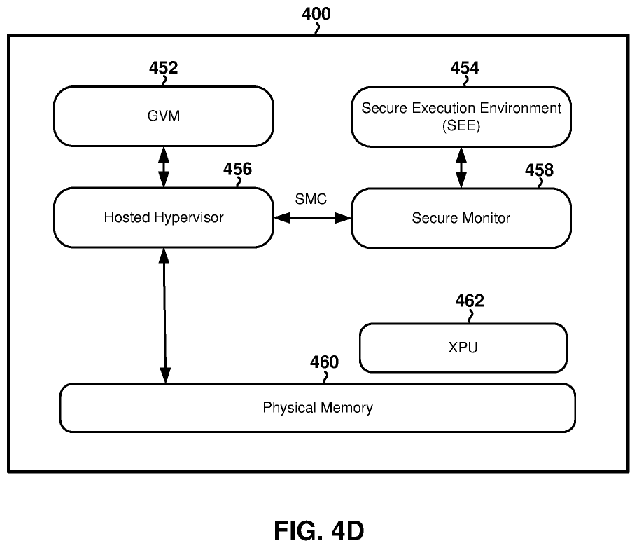

FIGS. 4A-4D illustrate example computing architectures suitable for use in some embodiments. With reference to FIG. 1-4A, a layered computer system architecture 400 may include both software components 401 and hardware components 403. The software components 401 may include an operating system 402, a library module 404, and one or more application programs (A₀ through Aₙ) 406. The hardware components 403 may include peripherals 408 (e.g., hardware accelerators, input/output devices, etc.), a central processing unit (CPU) 410, a central processing unit memory management unit (CPU MMU) 416, one or more system memory management units (herein “system MMU” or “SMMU”) 412, and one or more memories 414.

Application software written for mobile computing devices may be compiled into executable code, which is what is commonly referred to as “applications,” “apps,” or application programs 406. Each application program 406 may be a single process or thread, or may include a plurality of processes or threads.

Application programs 406 may issue high-level language (HLL) library calls to the library module 404 via an application program interface (API). The library module 404 may invoke services (e.g., via operating system calls) on the operating system 402 via an application binary interface (ABI). The operating system 402 may communicate with the hardware components using a specific instruction set architecture (ISA), which is a listing of specific operation codes (opcode) and native commands implemented by the hardware 403. In this manner, the instruction set architecture may define the hardware 403 as seen by the operating system 402.

The operating system 402 may be responsible for coordinating and controlling the allocation and use of the various memories 414 amongst the application programs 406, which may include partitioning the physical memory across the multiple application programs (A0-An) 406. In an embodiment, the operating system 402 may include one or more memory management systems (e.g., a virtual memory manager, etc.) for managing the allocation and use of system memory by the various application programs (A₀ through Aₙ) 406. The memory management systems may function to ensure that the memory used by one process does not interfere with memory already in use by another process.

In an embodiment, the operating system 402 may include a virtual memory manager (OS VMM) configured to perform “virtual addressing” operations that enable the operating system 402 to make a particular physical address appear to be another address (i.e., a virtual address). The virtual addressing operations may include allocating virtual memory address to the application programs (A₀-Aₙ) 406. Including a virtual memory manager within the operating system 402 may simplify the coordination and control of the system memory among the multiple processes or application programs (A₀-Aₙ) 406.

In addition to the software-based memory management systems (e.g., OS VMM, etc.) discussed above, the system may include one or more hardware-based memory management systems, such as the CPU MMU 416 and the system MMU 412. The CPU MMU 416 and the system MMU 412 may each include one or more hardware components responsible for performing various memory related operations, such as the translation of virtual addresses to physical addresses, cache control, bus arbitration, and memory protection. In an embodiment, the CPU MMU 416 may be responsible for providing address translation services and protection functionalities to the main CPU 410, and the system MMU 412 may be responsible for providing address translation services and protection functionalities to other hardware components (e.g., digital signal processor, modem processor, graphics processor, etc.).

In various embodiments, one or more of the memory management systems (e.g., system MMU 412, CPU MMU 416, etc.) may include a translation look-aside buffer (TLB), which is a cache memory that may be used for memory address translations (e.g., translating virtual addresses to physical addresses, etc.). In an embodiment, the TLB may be a content-addressable memory (CAM), which may be a hardware associative array memory in which stored information is organized into key-value format (e.g., hash table). The keys may be virtual addresses and the values may be physical addresses.

Some processor systems only support a single stage of the memory address translation process and require the hypervisor to manage the relationship between virtual addresses, intermediate physical addresses, and physical addresses. This is generally achieved by the hypervisor maintaining its own translation tables (called shadow translation tables), which may be derived by interpreting each of the guest operating system's translation tables. On such systems, the hypervisor ensures that all changes to the guest operating system's translation tables are reflected in the shadow structures, as well as enforce protections and redirecting access faults to the appropriate stage.

Some processor systems provide hardware assistance for both stages of memory translation. For example, ARM processors may include Virtualization Extensions that enable the guest operating system to translate the virtual addresses to intermediate physical addresses in a first stage (i.e., first stage translations), and for hardware to translate the intermediate physical addresses to physical addresses in a second stage (i.e., second stage translations). Such Virtualization Extensions reduce the overheads associated with executing, maintaining, and/or managing the hypervisor, and improve computing device performance.

The various embodiments may utilize virtualization techniques. Virtualization technologies enable the abstraction (or virtualization) of computing resources, which may be achieved by placing a control program (e.g., a Virtual Machine Monitor “VMM” or hypervisor) between the operating system and the hardware. Virtualization techniques are commonly implemented in a virtual machine (VM), which may be a software application that executes application programs like a physical hardware machine. Virtual machines may be categorized into two general categories: system virtual machines and process virtual machines. System virtual machines allow the sharing of the underlying physical hardware between different processes or applications. Process virtual machines, on the other hand, may support a single process or application.

FIG. 4B is a layered architectural diagram illustrating the logical layers in a computing device implementing a process virtual machine. With reference to FIG. 1-4B, the virtualization component 422 may be a software component that runs on the hardware 403 and/or on top of the operating system 402 to emulate the hardware ISA and/or to otherwise provide the application programs with virtualized hardware resources. As discussed above, hardware components are only visible to the application programs 406 through the operating system 402, and the ABI and API effectively define the hardware features available to the application programs 406. As such, the virtualization component 422 may perform logical operations at the ABI/API level and/or emulate operating system calls or library calls such that the application programs 406 communicate with the virtualization component 422 in the same manner they would otherwise communicate with hardware components (i.e., via system/library calls). In this manner, the application programs 406 view the combination of the virtualization component 422, operating system 406, and hardware 408 as a single machine, such as the guest virtual machine (GVM) 420 illustrated in FIG. 4B. This simplifies the job of the application developer since application software need not be concerned with the actual architecture of computing devices on which the application will ultimately execute.

The GVM 420 illustrated in FIG. 4B exists solely to support a single application program 406. As such, it is created with the application program 406 and terminated when the application program 406 finishes execution. An application program 406 that runs on the virtual machine is called the “guest” and the underlying platform is called the “host.” Virtualization software 404 that implements the process virtual machine is typically called runtime software (or simply “runtime”).

FIG. 4C is a layered architectural diagram illustrating the logical layers in a computing device implementing a system virtual machine. With reference to FIG. 1-4C, the computer system may include hardware components (e.g., execution hardware, memory, I/O devices, etc.) 403 and software components that include an application programs 406, an operating system 406, and a virtualization component 422. Software that runs on top of the virtualization component 422 is referred to as “guest” software and the underlying platform that supports the virtualization module is referred to as “host” hardware.

Unlike process virtual machines, a system virtual machine provides a complete environment on which multiple guest operating systems 432 may coexist. Likewise, the host hardware platform may be configured to simultaneously support multiple, isolated guest operating system environments. The isolation between the concurrently executing operating systems adds a level of security to the system. For example, if security on one guest operating system is breached, or if one guest operating system suffers a failure, the software running on other guest systems is not affected by the breach/failure. The host hardware platform also simplifies the job of the application developer since application software need not be concerned with the actual architecture of computing devices on which the application will ultimately execute.

In the example illustrated in FIG. 4C, the virtualization component 422 is logically situated between the host hardware and the guest software. The virtualization component 422 may run on the actual hardware (native) or on top of an operating system (hosted), and is typically referred to as a “hypervisor” or virtual machine monitor (VMM). In native configurations, the virtualization component 422 runs on the actual hardware in the highest privilege mode available, and the guest operating systems 432 run with reduced privileges such that the virtualization component 422 can intercept and emulate all guest operating system actions that would normally access or manipulate the hardware resources. In hosted configurations, the virtualization component 422 runs on top of an existing host operating system 402, and may rely on the host operating system 402 to provide device drivers and other lower-level services. In either configuration (native or hosted), the guest operating systems 432 communicate with the virtualization component 422 in the same manner they would communicate with the physical hardware 403, viewing the combination of the virtualization component 422 and hardware 403 as a single guest virtual machine (GVM) 430. This allows each guest operating system 432 to operate under the illusion of having exclusive access to processors, peripherals, I/O, MMUs, and memories in the hardware 403.

FIG. 4D illustrates a computing system 400 that includes a guest virtual machine (GVM) 452, a secure execution environment 454 (e.g., ARM TrustZone®), a hosted hypervisor 456, a security monitor 458, and physical memory 460. In some embodiments, the computing system 400 may also include a Cross-Privilege-Unit (XPU) 462.

The hosted hypervisor 456 may facilitate the mapping of intermediate physical addresses (IPA) maintained by the GVM 452 to physical addresses (PA) in the physical memory 460, and otherwise act as an intermediary between the GVM 452 and the physical memory 460 or other hardware 403.

To ensure the security and isolation of the GVM 452, it is often necessary to use a secure monitor 458 to manage certain sensitive operations. One such operation is the sharing of memory between the GVM 452 and the secure execution environment 454. The secure monitor 458 may be invoked through a special instruction known as a secure monitor call (SMC). The SMC allows the GVM 452 to request access to the secure execution environment memory or to perform other sensitive operations, such as accessing cryptographic keys or controlling hardware peripherals. The SMC is typically only accessible to the secure monitor 458, so it serves as a gatekeeper to ensure that only trusted code can access the secure execution environment and its resources.

Thus, the SMC and security monitor 458 may operate as a gatekeeper, ensuring only secure data enters and exits the secure execution environment 454. The use of SMC and the secure monitor 458 allows for the secure communications and the sharing of memory between the GVM 452 and the secure execution environment 454, helping to ensure the security and integrity of both environments.

An XPU 462 may operate to help protect the processor and system against security vulnerabilities and attacks by enforcing privilege and memory isolation. An XPU is a hardware feature in some SOCs that may be used to enforce security boundaries, such as between the secure and normal worlds 454. The XPU may accomplish this by preventing the normal world from accessing certain resources (e.g., buffers, registers, etc.) that should only be accessible to the secure world. These resources include buffers used to temporarily store data during processing. Locking the buffers via the XPU 462 during processing helps to ensure that sensitive data in the secure world (e.g., secure execution environment 454) is protected from tampering or exploitation by processes in the normal world (e.g., GVM 452).

An XPU lock may be used to protect shared resources from being accessed simultaneously by different privilege levels (e.g., user mode, supervisor mode, etc.). Said another way, a XPU lock may used to prevent multiple privilege levels from accessing a shared resource at the same time. For example, the computing system 400 configured to identify a shared resource (e.g., buffer) that needs to be protected, determine the privilege level(s) that should be allowed to access the shared resource, and use XPU lock instructions to set the XPU lock for the shared resource. Using XPU lock instructions may include using a memory coprocessor register (MCR) instruction to write to a coprocessor register in the system coprocessor (CP15). The computing system 400 may then access the shared resource using the appropriate privilege level. When the access to the shared resource is complete, the computing system may use the XPU lock instructions to release the lock.

While an XPU lock is effective in preventing simultaneous access to a shared resource from different privilege levels, it may not prevent multiple accesses from the same privilege level. Protection against simultaneous access from the same privilege level may be accomplished by the computing system 400 using other synchronization mechanisms (e.g., mutexes, semaphores, etc.).

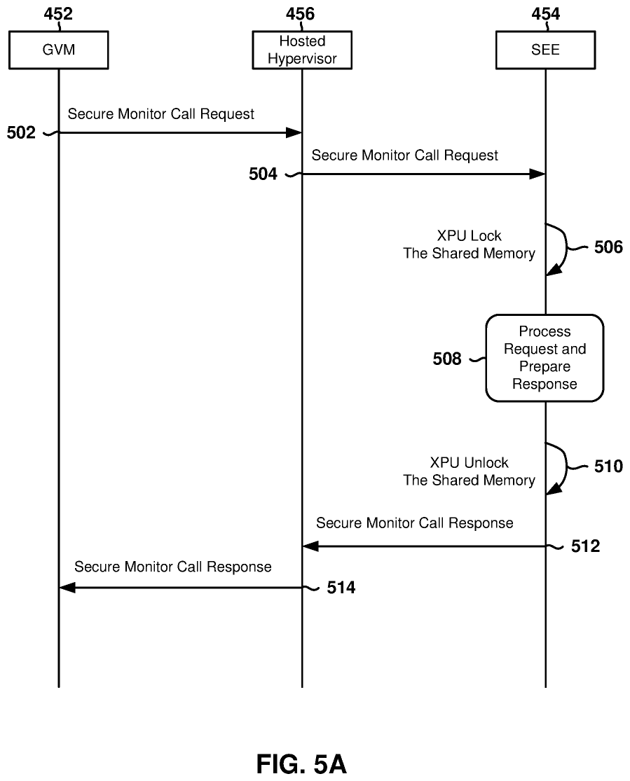

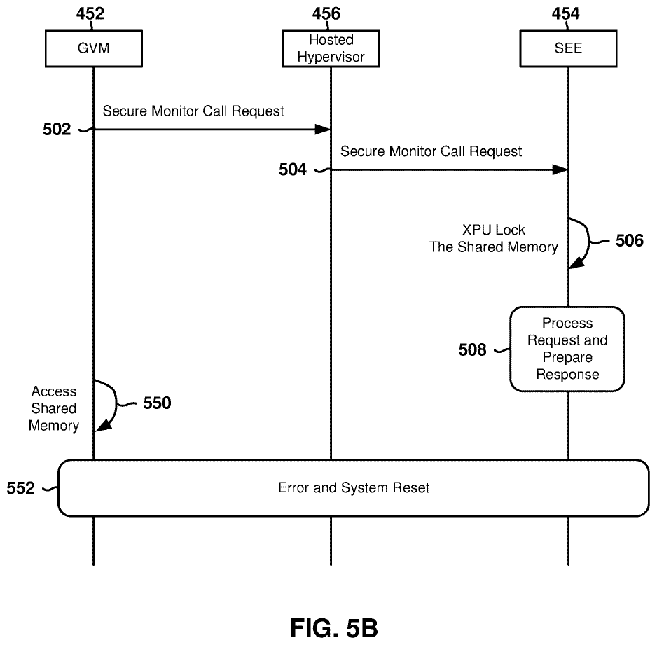

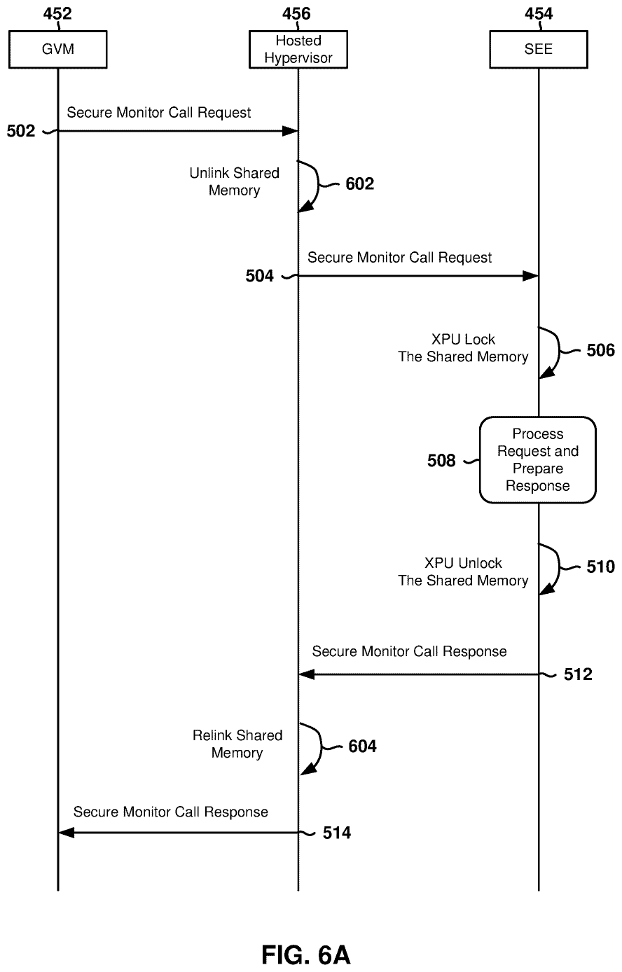

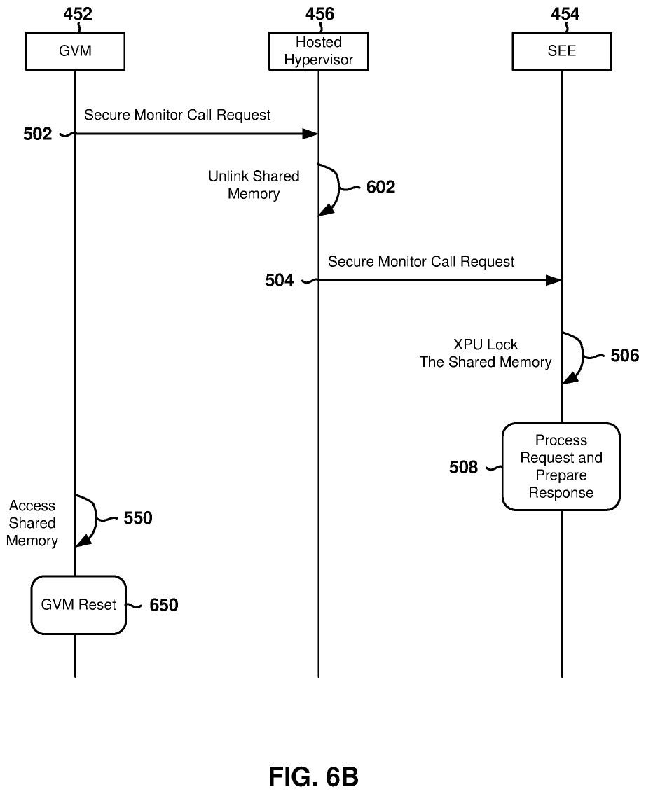

FIGS. 5A, 5B, 6A and 6B illustrate components in a computing system configured to use secure monitor calls (SMC) to manage sensitive operations in accordance with some embodiments. In particular, FIG. 5A illustrates a conventional solution for using SMCs. FIG. 5B illustrates that the conventional solution illustrated in FIG. 5A may result in system-wide errors and/or a system reset. FIGS. 6A and 6B illustrate methods of using SMCs in accordance with the various embodiments to avoid system-wide errors and system resets. In the examples illustrated in FIGS. 5A-6B, the computing system includes a guest virtual machine (GVM) 452, a secure execution environment (SEE) 454, and a hosted hypervisor 456.

With reference to FIGS. 1-5A, in operation 502, the GVM 452 may send a secure monitor call request to the hosted hypervisor 456. In operation 504, the hosted hypervisor 456 may send the secure monitor call request to the secure execution environment 454. In operation 506, the secure execution environment 454 may use the XPU to lock the shared memory (i.e., the memory shared between the GVM 452 and the secure execution environment 454). In operation block 508, the secure execution environment 454 may process the secure monitor call request and prepare/generate a secure monitor call response. In operation 510, the secure execution environment 454 may use the XPU to unlock the shared memory. In operation 512, the secure execution environment 454 may send a secure monitor call response to the hosted hypervisor 456. In operation 514, the hosted hypervisor 456 may send the secure monitor call response to the GVM 452.

In the example illustrated in FIG. 5B, in operation 550, the GVM 452 attempts to access the memory shared between the GVM 452 and the secure execution environment 454 prior to the secure execution environment 454 unlocking the shared memory (e.g., in operation 512). In response, to preserve security, the secure execution environment 454 may trigger a system level reset (similar to Time Of Check to Time Of Use). The computing system may generate an error and perform a system level reset in operation block 552.

System level resets are a safety problem on automotive platforms because they reset the hosted hypervisor, which may be responsible for managing a wide variety of the vehicle's functions and operations. As such, an unexpected system level reset while the vehicle is operating may cause the vehicle to crash.

FIGS. 6A and 6B illustrate methods of using secure monitor calls (SMC) without triggering system level resets. With reference to FIGS. 1-6A, in response to receiving the secure monitor call request in operation 502, the hosted hypervisor 456 may unlink the shared memory in operation 602.

In some embodiments, the hosted hypervisor 456 may unlink the shared memory by unmapping the shared memory in operation 602. In some embodiments, the hosted hypervisor may unmap this memory by modifying the mapping of virtual addresses to physical addresses in the system's MMU. This may be accomplished by modifying the page tables or by using other memory management features, such as memory protection or virtualization, to prevent the GVM 452 and SEE 454 from accessing the same shared memory at the same time. The operation for unmapping shared memory may depend on the specific implementation of the hosted hypervisor and the system's hardware and software architecture.

In some embodiments, the hosted hypervisor 456 may unlink the shared memory in operation 602 by using intermediate buffers so that the GVM 452 and the SEE 454 will not attempt to access the same memory region at the same time. For example, the hosted hypervisor 456 may create a virtualized memory space for the GVM 452, map the virtualized memory space to the physical memory of the host system through the intermediate buffers, which may act as a bridge between the GVM 452 and the host system's physical memory. The intermediate buffers may allow the GVM 452 and SEE 454 to access different portions of the physical memory, ensuring that they do not share the same memory space. This separation of memory helps to increase the security and isolation of the GVM 452 and the host system, as well as the SEE 454.

In operations 504-512, the SEE 454 and hosted hypervisor 456 may perform operations 504-512 discussed above with reference to FIG. 5A. In response to receiving the secure monitor call response in operation 512, the hosted hypervisor 456 may relink the shared memory in operation 604. In some embodiments, the hosted hypervisor 456 may relink the shared memory by remapping the memory. In some embodiments, the hosted hypervisor 456 may relink the shared memory by removing intermediate buffers so that the GVM and secure execution environment access the same memory regions again. In operation 514, the hosted hypervisor 456 may send the secure monitor call response to the GVM 452.

With reference to FIGS. 1-6B, in operation 550, the GVM 452 may attempt to access the memory shared between the GVM 452 and the secure execution environment 454 prior to the secure execution environment 454 unlocking the shared memory (e.g., in operation 512). However, unlike the example discussed above with reference to FIG. 5B, the memory was unmapped in operation 602 so that the secure execution environment 454 is not able to trigger a system level reset. Rather, in operation block 650, only the GVM 452 is reset. The other applications, components, and sub-systems on the computing device and vehicle are not impacted and may continue to operate on the device.

Thus, the example illustrated in FIG. 6B restricts the reset to the GVM 452. That is, while a TOCTOU type vulnerability may cause a S2 MMU fault in operation block 650 that leads to a crash of the GVM 452, it does not cause an XPU fault that forces a system level reset. In addition, un-mapping the memory allows the hosted hypervisor to send the SMC to the secure execution environment without significant delay, thereby improving the system's security without having a significant negative impact the latency of the SMCs. This in turn improves the performance and functioning of the controller, SOC, and/or vehicle.

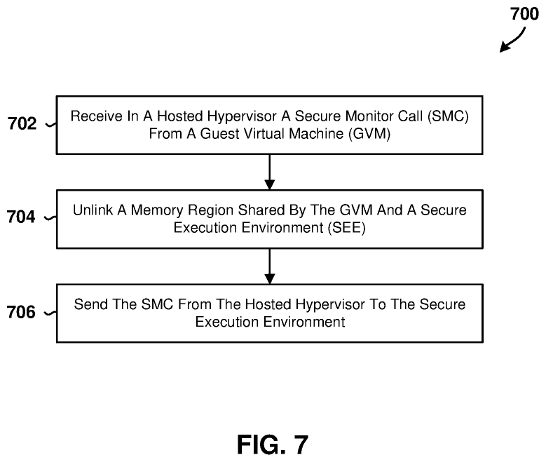

FIG. 7 illustrates a method 700 of unlinking shared memory for secure monitor calls (SMC) to prevent system-level resets in accordance with some embodiments. Method 700 may be performed by a processor in a computing device that includes a hosted hypervisor.

With reference to FIGS. 1-7, in block 702, the hosted hypervisor may receive an SMC from a guest virtual machine (GVM) of the computing device. In block 704, the hosted hypervisor may unlink a memory region shared by the GVM and a secure execution environment (SEE) of the computing device. In some embodiments, unlinking the memory region shared by the GVM and the secure execution environment in block 704 may be performed in response to the hosted hypervisor receiving the SMC from the GVM.

In some embodiments, unlinking the memory region in block 704 may include unmapping the memory region shared by the GVM and the secure execution environment. Generally, the operations for unmapping a shared memory depend on the specific implementation of the hosted hypervisor and the system's hardware and software architecture. For example, in some embodiments, the hosted hypervisor may unmap the shared memory region by modifying the mapping of virtual addresses to physical addresses in the system's MMU. This may be accomplished by modifying the page tables or by using other memory management features, such as memory protection or virtualization, to prevent the GVM and SEE from accessing the same physical memory at the same time.

In some embodiments, unlinking the memory region in block 704 may include using an intermediate buffer so that the GVM and the secure execution environment access different portions of physical memory to read or write to the memory region shared by the GVM and the secure execution environment. For example, the hosted hypervisor may create a virtualized memory space for the GVM and map the virtualized memory space to physical memory through an intermediate buffer. The intermediate buffer may serve to operate as a bridge between the GVM and the physical memory.

In block 706, the hosted hypervisor may send the SMC from the hosted hypervisor to the secure execution environment.

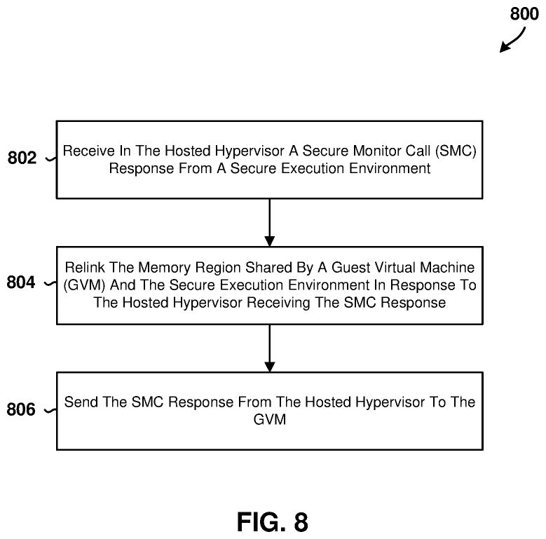

FIG. 8 illustrates a method 800 of relinking shared memory for SMC response in accordance with some embodiments. Method 800 may be performed by a processor in a computing device that includes a hosted hypervisor.

With reference to FIGS. 1-8, in block 802 the hosted hypervisor may receive an SMC response from the secure execution environment. In block 804, the hosted hypervisor may relink the memory region shared by the guest virtual machine (GVM) and the secure execution environment. For example, the hosted hypervisor may remap the shared memory or deallocate an intermediate buffer. In block 806, the hosted hypervisor may send the SMC response to the GVM.

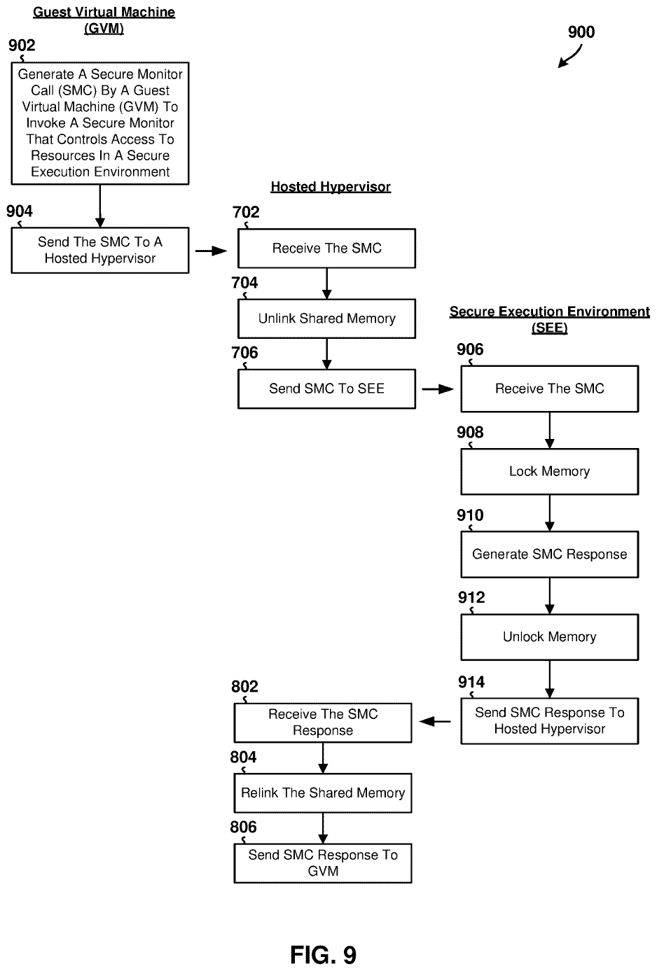

FIG. 9 is a process flow diagram that illustrates a method 900 of using secure monitor calls (SMC) in accordance with some embodiments. Method 700 may be performed by a processor in a computing device that includes a guest virtual machine (GVM), a hosted hypervisor, and a secure execution environment (SEE).

With reference to FIGS. 1-9, in block 902 the GVM may generate an SMC to invoke a secure monitor that controls access to resources in a secure execution environment. In block 904, the GVM may send the SMC to the hosted hypervisor.

In blocks 702-706, the hosted hypervisor may perform the operations discussed above with reference to FIG. 7. For example, the hosted hypervisor may receive the SMC in block 702, unlink the shared memory in block 704, and send the SMC to the SEE in block 706.

In block 906, the SEE may receive the SMC from the hosted hypervisor. In block 908, the SEE may lock the memory region shared by the GVM and the secure execution environment. In some embodiments, the SEE may use an XPU lock to lock the memory in block 908. For example, the SEE may use XPU lock instructions to set the XPU lock, such as by using a memory coprocessor register (MCR) instruction to write to a coprocessor register in the system coprocessor (CP15).

In block 910, the SEE may generate an SMC response. In block 912, the SEE may unlock the shared memory. In block 914, the SEE may send the generated SMC response to the hosted hypervisor.

In blocks 802-806, the hosted hypervisor may perform the operations discussed above with reference to FIG. 8. For example, the hosted hypervisor may receive the SMC response in block 802, relink the shared memory in block 804, and send the SMC to the SEE in block 806.

Various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment. For example, one or more of the operations of the methods 700-900 may be substituted for or combined with one or more operations of the methods 700-900.

The processors discussed in this application may be any programmable microprocessor, microcomputer or multiple processor chip or chips that can be configured by software instructions (applications) to perform a variety of functions, including the functions of the various embodiments described above. In some devices, multiple processors may be provided, such as one processor dedicated to wireless communication functions and one processor dedicated to running other applications. Typically, software applications may be stored in the internal memory before they are accessed and loaded into the processors. The processors may include internal memory sufficient to store the application software instructions. In many devices, the internal memory may be a volatile or nonvolatile memory, such as flash memory, or a mixture of both. For the purposes of this description, a general reference to memory refers to memory accessible by the processors including internal memory or removable memory plugged into the device and memory within the processors themselves. Additionally, as used herein, any reference to a memory may be a reference to a memory storage and the terms may be used interchangeable.

A number of different types of memories and memory technologies are available or contemplated in the future, any or all of which may be included and used in systems and computing devices that implement the various embodiments. Such memory technologies/types may include non-volatile random-access memories (NVRAM) such as Magnetoresistive RAM (M-RAM), resistive random access memory (ReRAM or RRAM), phase-change random-access memory (PC-RAM, PRAM or PCM), ferroelectric RAM (F-RAM), spin-transfer torque magnetoresistive random-access memory (STT-MRAM), and three-dimensional cross point (3D-XPOINT) memory. Such memory technologies/types may also include non-volatile or read-only memory (ROM) technologies, such as programmable read-only memory (PROM), field programmable read-only memory (FPROM), one-time programmable non-volatile memory (OTP NVM). Such memory technologies/types may further include volatile random-access memory (RAM) technologies, such as dynamic random-access memory (DRAM), double data rate (DDR) synchronous dynamic random-access memory (DDR SDRAM), static random-access memory (SRAM), and pseudostatic random-access memory (PSRAM). Systems and computing devices that implement the various embodiments may also include or use electronic (solid-state) non-volatile computer storage mediums, such as FLASH memory. Each of the above-mentioned memory technologies include, for example, elements suitable for storing instructions, programs, control signals, and/or data for use in or by a vehicle's advanced driver assistance system (ADAS), system on chip (SOC) or other electronic component. Any references to terminology and/or technical details related to an individual type of memory, interface, standard or memory technology are for illustrative purposes only, and not intended to limit the scope of the claims to a particular memory system or technology unless specifically recited in the claim language.

Implementation examples are described in the following paragraphs. While some of the following implementation examples are described in terms of example methods, further example implementations may include: the example methods discussed in the following paragraphs implemented by a computing device including a processor configured with processor-executable instructions to perform operations of the methods of the following implementation examples; the example methods discussed in the following paragraphs implemented by a computing device including means for performing functions of the methods of the following implementation examples; and the example methods discussed in the following paragraphs may be implemented as a non-transitory processor-readable storage medium having stored thereon processor-executable instructions configured to cause a processor of a computing device to perform the operations of the methods of the following implementation examples.

Example 1: A method performed by one or more processors of computing device that includes receiving in a hosted hypervisor a secure monitor call (SMC) from a guest virtual machine (GVM), unlinking by the hosted hypervisor a memory region shared by the GVM and a secure execution environment (SEE) in response to the hosted hypervisor receiving the SMC, and sending by the hosted hypervisor the SMC to the secure execution environment.

Example 2: The method of example 1, in which unlinking the memory region shared by the GVM and the secure execution environment in response to the hosted hypervisor receiving the SMC includes unmapping the memory region shared by the GVM and the secure execution environment.

Example 3: The method of example 1, in which unlinking the memory region shared by the GVM and the secure execution environment in response to the hosted hypervisor receiving the SMC includes using an intermediate buffer so that the GVM and the secure execution environment access different portions of physical memory to read or write to the memory region shared by the GVM and the secure execution environment.

Example 4: The method of example 3, in which using the intermediate buffer so that the GVM and the secure execution environment access different portions of physical memory to read or write to the memory region shared by the GVM and the secure execution environment includes creating a virtualized memory space for the GVM and mapping the virtualized memory space to physical memory through the intermediate buffer so that the intermediate buffer acts as a bridge between the GVM and the physical memory.

Example 5: The method of any of examples 1-4, in which the method further includes receiving the SMC in the secure execution environment, locking by the secure execution environment the memory region shared by the GVM and the secure execution environment, generating by the secure execution environment the SMC response, and sending the SMC response to the hosted hypervisor.

Example 6: The method of example 5, in which locking by the secure execution environment the memory region shared by the GVM and the secure execution environment includes using a Cross-Privilege-Unit (XPU) lock to lock the memory region shared by the GVM and the secure execution environment.

Example 7: The method of any of examples 1-5, in which the method further includes generating the SMC by the GVM to invoke a secure monitor that controls access to resources in the secure execution environment.

The foregoing method descriptions and the process flow diagrams are provided merely as illustrative examples and are not intended to require or imply that the steps of the various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

As used in this application, the terms “component,” “comparator,” “encoder,” “element” “system,” and the like are intended to include a computer-related entity, such as, but not limited to, hardware, firmware, a combination of hardware and software, software, or software in execution, which are configured to perform particular operations or functions. For example, a component may be, but is not limited to, a process running on a processor, a processor, an object, an executable, a thread of execution, a program, and/or a computer. By way of illustration, both an application running on a computing device and the computing device may be referred to as a component. One or more components may reside within a process and/or thread of execution, and a component may be localized on one processor or core and/or distributed between two or more processors or cores. In addition, these components may execute from various non-transitory computer readable media having various instructions and/or data structures stored thereon. Components may communicate by way of local and/or remote processes, function or procedure calls, electronic signals, data packets, memory read/writes, and other known network, computer, processor, and/or process related communication methodologies.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the claims.

The hardware used to implement the various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a multiprocessor, but, in the alternative, the processor may be any conventional processor, controller, microcontroller, or state machine. A processor may also be implemented as a combination of computing devices, e.g., a combination of a DSP and a multiprocessor, a plurality of multiprocessors, one or more multiprocessors in conjunction with a DSP core, or any other such configuration. Alternatively, some steps or methods may be performed by circuitry that is specific to a given function.

In one or more exemplary embodiments, the functions described may be implemented in hardware, software, firmware, or any combination thereof. If implemented in software, the functions may be stored as one or more processor-executable instructions or code on a non-transitory computer-readable storage medium or non-transitory processor-readable storage medium. The steps of a method or algorithm disclosed herein may be embodied in a processor-executable software module, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to other embodiments without departing from the scope of the claims. Thus, the claims are not intended to be limited to the embodiments shown herein but are to be accorded the widest scope consistent with the following claims and the principles and novel features disclosed herein.

1. A computing device, comprising:
a processor configured to:
receive, in a hosted hypervisor, a secure monitor call (SMC) from a guest virtual machine (GVM);
unlink, by the hosted hypervisor, a memory region shared by the GVM and a secure execution environment (SEE) in response to the hosted hypervisor receiving the SMC; and
send, by the hosted hypervisor, the SMC to the secure execution environment.

2. The computing device of claim 1, wherein the processor is further configured to:
receive, in the hosted hypervisor, an SMC response from the secure execution environment;
relink, by the hosted hypervisor, the memory region shared by the GVM and the secure
execution environment in response to the hosted hypervisor receiving the SMC response; and
send, by the hosted hypervisor, the SMC response to the GVM.

3. The computing device of claim 1, wherein the processor is configured to unlink the memory region shared by the GVM and the secure execution environment in response to the hosted hypervisor receiving the SMC by:
unmapping the memory region shared by the GVM and the secure execution environment.

4. The computing device of claim 1, wherein the processor is configured to unlink the memory region shared by the GVM and the secure execution environment in response to the hosted hypervisor receiving the SMC by:
using an intermediate buffer so that the GVM and the secure execution environment access different portions of physical memory to read or write to the memory region shared by the GVM and the secure execution environment.

5. The computing device of claim 4, wherein the processor is configured to use the intermediate buffer so that the GVM and the secure execution environment access different portions of physical memory to read or write to the memory region shared by the GVM and the secure execution environment by:
creating a virtualized memory space for the GVM; and
mapping the virtualized memory space to physical memory through the intermediate buffer so that the intermediate buffer acts as a bridge between the GVM and the physical memory.

6. The computing device of claim 1, wherein the processor is further configured to:
receive the SMC in the secure execution environment;
lock, by the secure execution environment, the memory region shared by the GVM and the secure execution environment;
generate, by the secure execution environment, the SMC response; and send the SMC response to the hosted hypervisor.

7. The computing device of claim 6, wherein the processor is configured to lock, by the secure execution environment, the memory region shared by the GVM and the secure execution environment by:
using a Cross-Privilege-Unit (XPU) lock to lock the memory region shared by the GVM and the secure execution environment.

8. The computing device of claim 6, wherein the processor is configured to generate, by the GVM, the SMC to invoke a secure monitor that controls access to resources in the secure execution environment.

9. A method performed by one or more processors of computing device, comprising: receiving, in a hosted hypervisor, a secure monitor call (SMC) from a guest virtual machine (GVM);
unlinking, by the hosted hypervisor, a memory region shared by the GVM and a secure execution environment (SEE) in response to the hosted hypervisor receiving the SMC; and
sending, by the hosted hypervisor, the SMC to the secure execution environment.

10. The method of claim 9, further comprising:
receiving, in the hosted hypervisor, an SMC response from the secure execution environment;
relinking, by the hosted hypervisor, the memory region shared by the GVM and the secure execution environment in response to the hosted hypervisor receiving the SMC response; and
sending, by the hosted hypervisor, the SMC response to the GVM.

11. The method of claim 9, wherein unlinking the memory region shared by the GVM and the secure execution environment in response to the hosted hypervisor receiving the SMC comprises unmapping the memory region shared by the GVM and the secure execution environment.

12. The method of claim 9, wherein unlinking the memory region shared by the GVM and the secure execution environment in response to the hosted hypervisor receiving the SMC comprises using an intermediate buffer so that the GVM and the secure execution environment access different portions of physical memory to read or write to the memory region shared by the GVM and the secure execution environment.

13. The method of claim 12, wherein using the intermediate buffer so that the GVM and the secure execution environment access different portions of physical memory to read or write to the memory region shared by the GVM and the secure execution environment comprises:
creating a virtualized memory space for the GVM; and
mapping the virtualized memory space to physical memory through the intermediate buffer so that the intermediate buffer acts as a bridge between the GVM and the physical memory.

14. The method of claim 13, further comprising:
receiving the SMC in the secure execution environment;
locking, by the secure execution environment, the memory region shared by the GVM and the secure execution environment;
generating, by the secure execution environment, the SMC response; and sending the SMC response to the hosted hypervisor.

15. The method of claim 14, wherein locking, by the secure execution environment, the memory region shared by the GVM and the secure execution environment comprises using a Cross-Privilege-Unit (XPU) to lock the memory region shared by the GVM and the secure execution environment.

16. The method of claim 9, further comprising generating, by the GVM, the SMC to invoke a secure monitor that controls access to resources in the secure execution environment.

17.-24. (canceled)

25. A non-transitory processor-readable medium having stored thereon processor executable instructions configured to cause a processor of a computing device to perform operations comprising:
receiving, in a hosted hypervisor, a secure monitor call (SMC) from a guest virtual machine (GVM);
unlinking, by the hosted hypervisor, a memory region shared by the GVM and a secure execution environment (SEE) in response to the hosted hypervisor receiving the SMC; and
sending, by the hosted hypervisor, the SMC to the secure execution environment.

26. The non-transitory processor-readable medium of claim 25, wherein the stored processor-executable instructions are configured to cause the processor to perform operations further comprising:
receiving, in the hosted hypervisor, an SMC response from the secure execution environment;
relinking, by the hosted hypervisor, the memory region shared by the GVM and the secure execution environment in response to the hosted hypervisor receiving the SMC response; and
sending, by the hosted hypervisor, the SMC response to the GVM.

27. The non-transitory processor-readable medium of claim 25, wherein the stored processor-executable instructions are configured to cause the processor to perform operations such that unlinking the memory region shared by the GVM and the secure execution environment in response to the hosted hypervisor receiving the SMC comprises unmapping the memory region shared by the GVM and the secure execution environment.

28. The non-transitory processor-readable medium of claim 25, wherein the stored processor-executable instructions are configured to cause the processor to perform operations such that unlinking the memory region shared by the GVM and the secure execution environment in response to the hosted hypervisor receiving the SMC comprises using an intermediate buffer so that the GVM and the secure execution environment access different portions of physical memory to read or write to the memory region shared by the GVM and the secure execution environment.

29.-30. (canceled)
